(19) United States
(12) Patent Application Publication
(10) Pub. No.: US 2025/0209151 A1
(43) Pub. Date: Jun. 26, 2025

(54) MANAGEMENT DEVICE, MANAGEMENT METHOD, AND NON-TRANSITORY STORAGE MEDIUM

(71) Applicant: TOYOTA JIDOSHA KABUSHIKI KAISHA, Toyota-shi (JP)

(72) Inventors: Hiroki HOMMA, Toyota-shi (JP); Yosuke Hasegawa, Nagoya-shi (JP); Junji Murase, Nagoya-shi (JP); Yuki Mori, Seki-shi (JP)

(73) Assignee: TOYOTA JIDOSHA KABUSHIKI KAISHA, Toyota-shi (JP)

(21) Appl. No.: 18/960,836

(22) Filed: Nov. 26, 2024

(30) Foreign Application Priority Data
Dec. 21, 2023 (JP) 2023-215853

(51) Int. Cl. G06F 21/44

(52) U.S. Cl. CPC G06F 21/44

(57) ABSTRACT

A management device manages a digital key. The digital key is registered in a mobile information terminal to operate a vehicle. This management device includes a processor configured to execute a process for issuing a password on a condition that an owner key that is a digital key registered in the mobile information terminal of a vehicle owner is deleted from the mobile information terminal, the password being needed to reregister the owner key.

### CROSS-REFERENCE TO RELATED APPLICATION

This application claims priority to Japanese Patent Application No. 2023-215853 filed on Dec. 21, 2023, incorporated herein by reference in its entirety.

### BACKGROUND

### 1. Technical Field

The present disclosure relates to a management device, a management method, and a non-transitory storage medium.

### 2. Description of Related Art

As described in Japanese Unexamined Patent Application Publication Nos. 2023-98289 and 2023-131424, a digital key technology is known with which a vehicle is locked and unlocked, and an engine is started, according to operation signals transmitted from a mobile information terminal such as a smartphone.

### SUMMARY

An owner key is a digital key that is registered in a mobile information terminal of a vehicle owner. When registering the owner key in the mobile information terminal, it is preferable to require input of a password issued by a management device that manages the digital key.

Here, for example, when the mobile information terminal is replaced, a new password is needed to reregister the owner key in the mobile information terminal. Therefore, it is desirable to improve convenience by reducing time and effort required for reissue of the password.

A management device of the present disclosure is configured to manage a digital key, and the digital key is registered in a mobile information terminal to operate a vehicle. This management device includes a processor configured to execute a process for issuing a password on a condition that an owner key that is a digital key registered in a mobile information terminal of a vehicle owner is deleted from the mobile information terminal, the password being needed to reregister the owner key.

The processor may be configured to execute a process for transmitting the issued password to a digital key application that the mobile information terminal of the vehicle owner has.

The digital key application may include a first application, and a second application. The processor may be configured to transmit the issued password to the first application, and the issued password may be automatically input from the first application into the second application.

The processor may be configured to execute a process for transmitting an address of a home page to a mail account of the vehicle owner, and the home page is for automatically inputting the issued password into a digital key application that the mobile information terminal of the vehicle owner has.

The digital key application may include the first application, and the second application. The processor may be configured to transmit the issued password to the first application, in response to receipt of data from the mobile information terminal to which the address has been transmitted, and the issued password may be automatically input from the first application into the second application.

The processor may be configured to execute a process for transmitting the issued password to the mail account of the vehicle owner.

A management method of the present disclosure is a method for managing a digital key that is registered in a mobile information terminal to operate a vehicle. This management method includes issuing a password on a condition that an owner key that is a digital key registered in a mobile information terminal of a vehicle owner is deleted from the mobile information terminal, the password being needed to reregister the owner key.

A program of the present disclosure is a program to be executed by a management device for managing a digital key that is registered in a mobile information terminal to operate a vehicle. This program causes the management device to execute issuing a password on a condition that an owner key that is a digital key registered in a mobile information terminal of a vehicle owner is deleted from the mobile information terminal, the password being needed to reregister the owner key.

A non-transitory storage medium of the present disclosure stores instructions that are executable by one or more processors and that cause the one or more processors to perform functions including: managing an owner key that is a digital key registered in a mobile information terminal of a vehicle owner for operating a vehicle; and issuing a password on a condition that the owner key registered in the mobile information terminal is deleted from the mobile information terminal, the password being needed to reregister the owner key.

The management device, the management method, the program, and the non-transitory storage medium have the effects of reducing the time and effort required for reissue of the password that is needed to reregister the owner key in the mobile information terminal.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view schematically showing configurations of a management device, a vehicle, a mobile information terminal, and a device server of one embodiment;

FIG. 2 is a sequential view showing a flow of a password reissuing process of the embodiment;

FIG. 3 is a sequential view showing a flow of an owner-key reregistration process of the embodiment;

FIG. 4 is a sequential view showing a flow of an owner-key reregistration process of the embodiment; and

FIG. 5 is a sequential view showing a flow of an owner-key reregistration process of the embodiment.

### DETAILED DESCRIPTION OF EMBODIMENTS

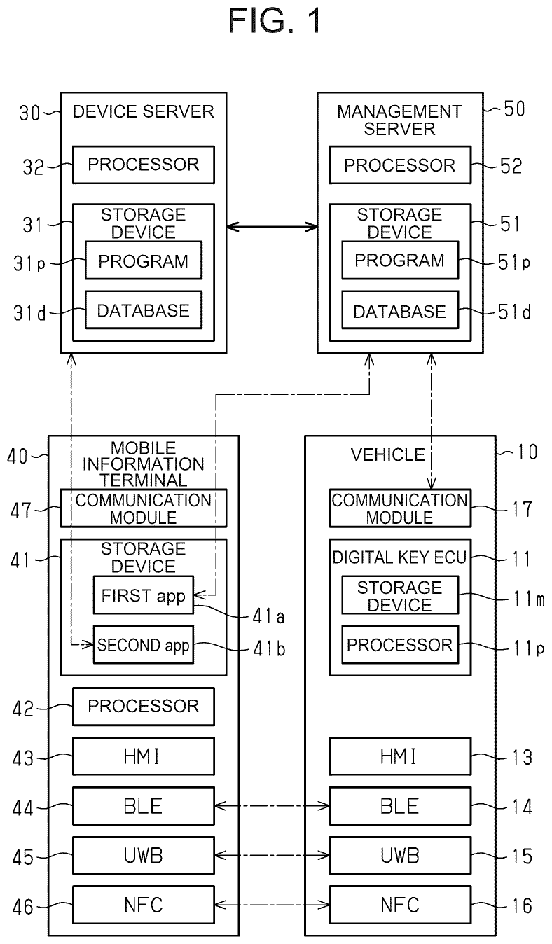

Hereinafter, one embodiment of a management device, a management method, a program, and a non-transitory storage medium will be described in detail with reference to FIG. 1 to FIG. 5.

### Configurations of Control Device and Vehicle

The configurations of the management device, the vehicle, the mobile information terminal, and the device server of the present embodiment will be described with reference to FIG. 1.

As shown in FIG. 1, a management server 50 that is the management device includes a storage device 51, and a processor 52. The storage device 51 includes various programs 51p, and a database 51d in which various kinds of information is recorded. The management server 50 performs various processes by causing the processor 52 to execute the programs 51p.

The management server 50 manages information about a digital key that locks and unlocks a vehicle 10, and starts an engine, according to operation signals transmitted from a mobile information terminal 40 such as a smartphone. Note that, hereinafter, a digital key registered in the mobile information terminal 40 of a vehicle owner will be referred to as the owner key. The management server 50 issues a password that is needed to register the digital key in the mobile information terminal 40, and a verification value for verifying the password. The management server 50 manages account information of a user who is the vehicle owner. The user's account information includes information about the vehicle owned by the user, a mail address of the user, etc.

The vehicle 10 includes a digital key electronic control unit (ECU) 11, a human-machine interface (HMI) 13, a Bluetooth (registered trademark) low energy (BLE) module 14, an ultra-wide band (UWB) module 15, a near-field communication (NFC) module 16, and a communication module 17.

The digital key ECU 11 is an ECU that manages and utilizes the digital key. The digital key ECU 11 has a storage device 11m, and a processor 11p. The digital key ECU 11 performs various processes by causing the processor 11p to execute programs stored in the storage device 11m.

The HMI 13 is a human-machine interface. The HMI 13 includes an input device, and a display device. The input device accepts an operation of the user on the vehicle 10. The display device displays information to the user by means of images and voice.

The BLE module 14 is a module that performs near-field communication with the mobile information terminal 40 to perform authentication for permitting digital key pairing between the mobile information terminal 40 and the vehicle 10, and vehicle operations using the mobile information terminal 40.

The vehicle operations include locking and unlocking of the vehicle 10, and starting of the engine.

The UWB module 15 is a module that measures the distance between the mobile information terminal 40 and the vehicle 10.

The NFC module 16 is a module that performs near-field communication with the mobile information terminal 40 to perform authentication for permitting digital key pairing between the mobile information terminal 40 and the vehicle 10, and vehicle operations using the mobile information terminal 40. The vehicle operations include locking and unlocking of the vehicle 10, and starting of the engine.

The communication module 17 is a module that performs intercommunication with the management server 50 through a mobile communication network.

The mobile information terminal 40 includes a storage device 41, a processor 42, an HMI 43, a BLE module 44, a UWB module 45, an NFC module 46, and a communication module 47.

The mobile information terminal 40 performs various processes by causing the processor 42 to execute programs stored in the storage device 41.

A first application 41a and a second application 41b are stored in the storage device 41. The first application and the second application will be hereinafter referred to as the first app and the second app, respectively.

The first app 41a is a program provided as a digital key application by a manufacturer of the vehicle 10. The first app 41a provides various user interfaces (UIs) related to the digital key, such as creation, deletion, activation, and deactivation of the digital key. The first app 41a obtains the user's account information and the like by performing intercommunication with the management server 50 through the mobile communication network.

The second app 41b is a program provided as a digital key application by a manufacturer and the like of the mobile information terminal 40. The second app 41b provides user interfaces (UIs) related to the digital key, such as creation, deletion, activation, and deactivation of the digital key. The second app 41b performs intercommunication with the device server 30 through the mobile communication network.

The HMI 43 is a human-machine interface. The HMI 43 includes an input device, and a display device. The input device accepts an operation of the user. The display device displays information to the user by means of images and voice.

The BLE module 44 is a module that performs near-field communication with the vehicle 10 to perform authentication for permitting digital key pairing between the mobile information terminal 40 and the vehicle 10, and vehicle operations using the mobile information terminal 40.

The UWB (ultra-wide band) module 45 is a module that measures the distance between the mobile information terminal 40 and the vehicle 10.

The near-field communication (NFC) module 46 is a module that performs near-field communication with the vehicle 10 to perform authentication for permitting digital key pairing between the mobile information terminal 40 and the vehicle 10, and vehicle operations using the mobile information terminal 40.

The communication module 47 is a module that performs intercommunication with the management server 50 and the device server 30 through the mobile communication network.

The device server 30 has a storage device 31, and a processor 32. The storage device 31 has various programs 31p, and a database 31d in which various kinds of information are recorded. The device server 30 performs various processes by causing the processor 32 to execute the programs 31p. The device server 30 performs intercommunication with the management server 50 through a communication network.

The device server 30 manages the mobile information terminal 40, and provides the second app 41b with data necessary for the mobile information terminal 40. The device server 30 provides the management server 50 with necessary data.

### Reissue of Password

When the user performs an operation to delete the owner key registered in the mobile information terminal 40 from the mobile information terminal 40, the management server 50 executes a process for issuing a password needed to reregister the owner key. An example of a case when the owner key is to be deleted from the mobile information terminal 40 is when the user changes the model of the mobile information terminal 40.

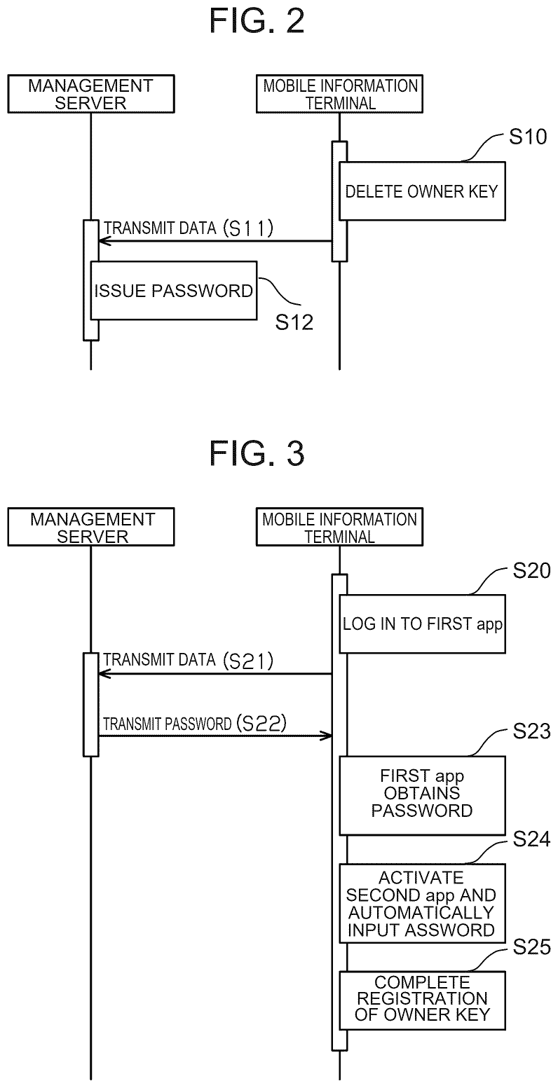

FIG. 2 shows a flow of a password reissuing process.

When the user deletes the owner key by operating the first app 41a or the second app 41b of the mobile information terminal 40 (S10), the mobile information terminal 40 transmits data to the management server 50 (S11). The data transmitted at this time includes data indicating that the owner key has been deleted.

When the management server 50 receives the data transmitted from the mobile information terminal 40, the management server 50 issues a password needed to reregister the owner key, and stores the password in the database 51d (S12).

### Reregistration of Owner Key

In the present embodiment, as methods for reregistering the owner key when the owner key is deleted from the mobile information terminal 40 after initial registration of the owner key in the mobile information terminal 40, a first method, a second method, and a third method are prepared. An example of a case when the owner key is to be reregistered is when the user has changed the model of the mobile information terminal 40.

### First Reregistration Method

FIG. 3 shows a flow of processes of the first method for reregistering the owner key, using the password reissued by the management server 50.

When the user logs in by activating the first app 41a of the mobile information terminal 40 and inputting an account (S20), the mobile information terminal 40 transmits data to the management server 50 (S21). The data transmitted at this time includes data indicating that the user has logged in to the first app 41a of the mobile information terminal 40, and data indicating the vehicle for which the owner key is to be reregistered.

When the management server 50 receives the data transmitted from the mobile information terminal 40, the management server 50 transmits the reissued password stored in the database 51d to the first app 41a of the mobile information terminal 40 to which the user has logged in (S22).

When the mobile information terminal 40 receives the password transmitted from the management server 50, the first app 41a obtains the password (S23).

Next, the mobile information terminal 40 activates the second app 41b, and automatically inputs the password obtained by the first app 41a into the second app 41b (S24).

When the password is automatically input into the second app 41b, authentication is performed, and registration of the owner key is completed in the mobile information terminal 40 (S25).

### Second Reregistration Method

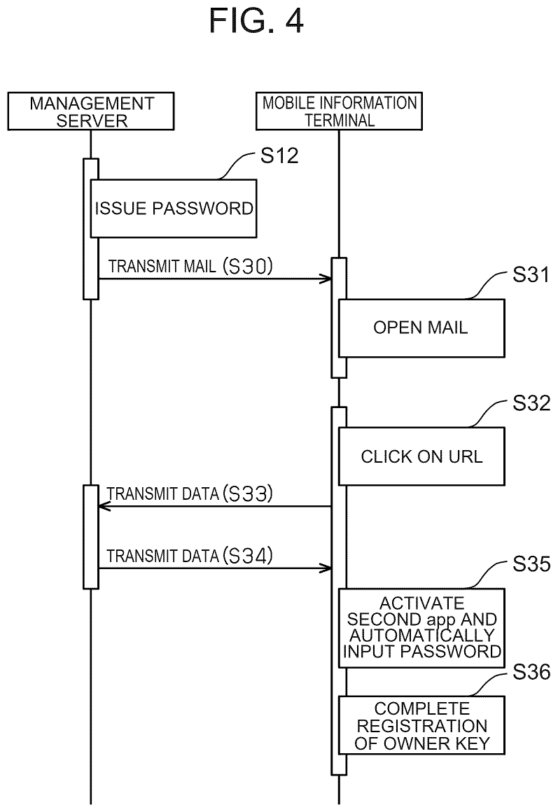

FIG. 4 shows a flow of processes of the second method for reregistering the owner key, using the password reissued by the management server 50.

When the management server 50 issues the password in the process of $12, the management server 50 transmits an email to the user's email account (S30). This e-mail contains a description of a uniform resource locator (URL) indicating an address of a home page for automatically inputting the password into the second app 41b that is a digital key application that the mobile information terminal 40 has.

Next, the user activates mail software in the mobile information terminal 40 and opens the email (S31).

Subsequently, when the user clicks on the URL described in the e-mail displayed by the mail software in the mobile information terminal 40 (S32), data is transmitted from the mobile information terminal 40 to the management server 50 (S33). The data transmitted at this time includes data indicating that the user has clicked on the URL.

When the management server 50 receives the data transmitted from the mobile information terminal 40, the management server 50 transmits data to the mobile information terminal 40 (S34). The data transmitted at this time includes the reissued password stored in the database 51d.

When the mobile information terminal 40 receives the password transmitted from the management server 50, the mobile information terminal 40 activates the second app 41b, and automatically inputs the received password into the second app 41b (S35).

When the password is automatically input into the second app 41b, authentication is performed, and registration of the owner key is completed in the mobile information terminal 40 (S36).

### Third Reregistration Method

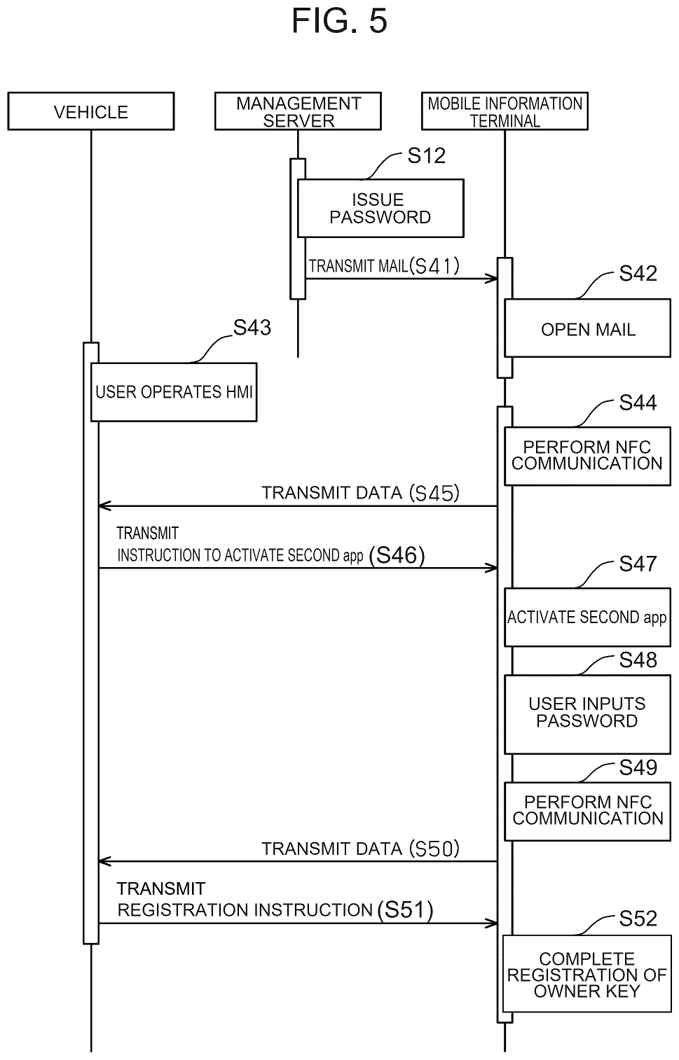

FIG. 5 shows a flow of processes of the third method for reregistering the owner key, using the password reissued by the management server 50.

When the management server 50 issues the password in the process of S12, the management server 50 transmits an email to the user's email account (S41). The password reissued by the management server 50 is described in this e-mail.

Next, the user activates mail software in the mobile information terminal 40 and opens the email (S42).

Subsequently, the user requests digital key pairing by operating the HMI 13 of the vehicle 10 (S43).

Next, the user brings the mobile information terminal 40 closer to the NFC module 16 of the vehicle 10 to perform communication between the NFC modules (S44).

When communication between the NFC modules is performed, the mobile information terminal 40 transmits data to the digital key ECU 11 in the vehicle 10 (S45). The data transmitted at this time includes data indicating that there is a request for digital key pairing.

When the digital key ECU 11 in the vehicle 10 receives the data transmitted from the mobile information terminal 40, the digital key ECU 11 transmits an instruction to activate the second app 41b to the mobile information terminal 40 (S46).

When the mobile information terminal 40 receives the instruction to activate the second app 41b, the mobile information terminal 40 activates the second app 41b (S47).

When the second app 41b is activated, the user inputs the password described in the email into the second app 41b (S48).

Next, the user brings the mobile information terminal 40 closer to the NFC module 16 of the vehicle 10 to perform communication between the NFC modules (S49).

When communication between the NFC modules is performed, the mobile information terminal 40 transmits data to the digital key ECU 11 in the vehicle 10 (S50). The data transmitted at this time includes data indicating that there is a request for approval of registration of the digital key.

When the digital key ECU 11 in the vehicle 10 receives the data transmitted from the mobile information terminal 40, the digital key ECU 11 transmits a registration instruction to the mobile information terminal 40 (S51).

When the mobile information terminal 40 receives the registration instruction, the mobile information terminal 40 performs authentication, and completes registration of the owner key (S52).

### Functions and Effects of the Present Embodiment

As shown in FIG. 2, when the owner key that is the digital key is deleted from the mobile information terminal 40, the management server 50 executes the process for issuing a password needed to reregister the owner key. Thus, the deletion of the owner key leads to issuing the password needed to reregister the owner key. Therefore, it is possible to reduce the time and effort required for reissue of the password.

In the first reregistration method shown in FIG. 3, the management server 50 executes the process for transmitting the issued password to the first app 41a that is a digital key application that the mobile information terminal 40 of the vehicle owner has (S22). Consequently, it is possible to save time and effort for the user to input the password.

In the second reregistration method shown in FIG. 4, the management server 50 executes the following process. Specifically, the management server 50 executes the process for transmitting, to the user's mail account, the address of the home page for automatically inputting the issued password into the second app 41b that is a digital key application that the mobile information terminal 40 of the vehicle owner has (S30). Consequently, it is possible to save time and effort for the user to input the password.

In the third reregistration method shown in FIG. 5, the management server 50 executes the process for transmitting the issued password to the mail account of the vehicle owner (S41). Compared to a case when the reissued password is notified to the user by mail or the like, the user can promptly know the reissued password. Therefore, for example, the owner key can be quickly reregistered.

### Modifications

The embodiment can be modified and implemented as follows. The embodiment and the following modifications can be implemented in combination with each other within a range in which there is no technical contradiction.

Although the first reregistration method, the second reregistration method, and the third reregistration method are prepared as the methods for reregistering the owner key, at least one of these reregistration methods may be prepared.

Although the mobile information terminal 40 has the first app 41a and the second app 41b, the first app 41a may be omitted when the first reregistration method is not employed.

The management device may be configured to include a circuitry including one or more processors that operate according to a computer program, one or more dedicated hardware circuits such as dedicated hardware that executes at least some of the various processes, or a combination of these processors and hardware circuits. An example of the dedicated hardware is an application specific integrated circuit (ASIC). The processor includes a central processing unit (CPU) and memory, such as random access memory (RAM) and read only memory (ROM), and the memory stores program codes or commands configured to cause the CPU to execute the processes. The memory, i.e., storage medium, includes every available medium accessible by general purpose or dedicated computers.

### Supplementary Items

Technical ideas that can be grasped from the embodiment and modifications will be described.

[Supplement 1] A management device for managing a digital key that is registered in a mobile information terminal to operate a vehicle, wherein the management device executes a process for issuing a password when an owner key that is a digital key registered in the mobile information terminal of a vehicle owner is deleted from the mobile information terminal, the password being needed to reregister the owner key.

[Supplement 2] The management device according to supplement 1, wherein the management device executes a process for transmitting the issued password to a digital key application that the mobile information terminal of the vehicle owner has.

[Supplement 3] The management device according to supplement 1 or 2, wherein the management devices executes a process for transmitting, to a mail account of the vehicle owner, an address of a home page for automatically inputting the issued password into a digital key application that the mobile information terminal of the vehicle owner has.

[Supplement 4] The management device according to any one of supplements 1 to 3, wherein the management device executes a process for transmitting the issued password to a mail account of the vehicle owner.

[Supplement 5] A management method for managing a digital key that is registered in a mobile information terminal to operate a vehicle, wherein the management method issues a password when an owner key that is a digital key registered in the mobile information terminal of a vehicle owner is deleted from the mobile information terminal, the password being needed to reregister the owner key.

[Supplement 6] The management method according to supplement 5, wherein the management method transmits the issued password to a digital key application that the mobile information terminal of the vehicle owner has.

[Supplement 7] The management method according to supplement 5 or 6, wherein the management method transmits, to a mail account of the vehicle owner, an address of a home page for automatically inputting the issued password into a digital key application that the mobile information terminal of the vehicle owner has.

[Supplement 8] The management method according to any one of supplements 5 to 7, wherein the management method transmits the issued password to a mail account of the vehicle owner.

[Supplement 9] A program to be executed by a management device for managing a digital key that is registered in a mobile information terminal to operate a vehicle, wherein the program causes the management device to issue a password when an owner key that is a digital key registered in the mobile information terminal of a vehicle owner is deleted from the mobile information terminal, the password being needed to reregister the owner key.

[Supplement 10] The program according to supplement 9, wherein the program causes the management device to execute a process for transmitting the issued password to a digital key application that the mobile information terminal of the vehicle owner has.

[Supplement 11] The program according to supplement 9 or 10, wherein the program causes the management device to execute a process for transmitting, to a mail account of the vehicle owner, an address of a home page for automatically inputting the issued password into a digital key application that the mobile information terminal of the vehicle owner has.

[Supplement 12] The program according to any one of supplements 9 to 11, wherein the program causes the management device to execute a process for transmitting the issued password to a mail account of the vehicle owner.

What is claimed is:

1. A management device configured to manage a digital key that is registered in a mobile information terminal to operate a vehicle, the management device comprising a processor configured to execute a process for issuing a password on a condition that an owner key that is a digital key registered in the mobile information terminal of a vehicle owner is deleted from the mobile information terminal, the password being needed to reregister the owner key.

2. The management device according to claim 1, wherein the processor is configured to execute a process for transmitting the issued password to a digital key application that the mobile information terminal of the vehicle owner has.

3. The management device according to claim 2, wherein
the digital key application includes a first application and a second application,
the processor is configured to transmit the issued password to the first application, and
the issued password is automatically input from the first application into the second application.

4. The management device according to claim 1, wherein
the processor is configured to execute a process for transmitting an address of a home page to a mail account of the vehicle owner, and
the home page is for automatically inputting the issued password into a digital key application that the mobile information terminal of the vehicle owner has.

5. The management device according to claim 4, wherein
the digital key application includes a first application and a second application,
the processor is configured to transmit the issued password to the first application, in response to receipt of data from the mobile information terminal to which the address has been transmitted, and
the issued password is automatically input from the first application into the second application.

6. The management device according to claim 1, wherein the processor is configured to execute a process for transmitting the issued password to a mail account of the vehicle owner.

7. A method for managing a digital key that is registered in a mobile information terminal to operate a vehicle, the method comprising issuing a password on a condition that an owner key that is a digital key registered in the mobile information terminal of a vehicle owner is deleted from the mobile information terminal, the password being needed to reregister the owner key.

8. A non-transitory storage medium storing instructions that are executable by one or more processors and that cause the one or more processors to perform functions comprising:
managing an owner key that is a digital key registered in a mobile information terminal of a vehicle owner for operating a vehicle; and
issuing a password on a condition that the owner key registered in the mobile information terminal is deleted from the mobile information terminal, the password being needed to reregister the owner key.
